(19) United States
(12) Patent Application Publication
(10) Pub. No.: US 2008/0013037 A1
(43) Pub. Date: Jan. 17, 2008

(54) EYEGLASS-MOUNTED VIRTUAL DISPLAY SYSTEM

(76) Inventor: Jerome T. Carollo, Carlsbad, CA (US)

Correspondence Address: VIERRA MAGEN MARCUS & DENIRO LLP, 575 MARKET STREET SUITE 2500, SAN FRANCISCO, CA, 94105, US

(21) Appl. No.: 11/553,358

(22) Filed: Oct. 26, 2006

Related U.S. Application Data
(63) Continuation-in-part of application No. 11/487,671, filed on Jul. 17, 2006, now abandoned.

(51) Int. Cl. G02C 5/00

(52) U.S. Cl. 351/41

(57) ABSTRACT

A virtual display system mounted on conventional eyewear. Preferably, an opening is formed in a lens of the eyewear, and a grommet is adapted to snugly fit into the opening. A housing is adapted to snugly fit into the grommet. The housing includes a ball and socket assembly, wherein the ball is rotatable within the socket. A collimating display system apparatus is adapted to fit within the ball thereby permitting adjustment by the user.

This application is a continuation-in-part of U.S. application Ser. No. 11/487,671.

### TECHNICAL FIELD

The present disclosure relates generally to virtual display systems and, more particularly, to an eyeglass-mounted collimating display system that provides a large field of view in a small, lightweight package.

### BACKGROUND

Virtual display systems are generally known, wherein a head- or helmet-mounted assembly includes a collimating display system apparatus, which generally consists of a display and collimating optics that allow the user to comfortably view the displayed image. Typically, the collimating display system apparatus included in such assemblies is large enough to mandate that the mounting of such an apparatus must be to a head-or helmet mounted assembly. Further, the support mechanism for the collimating display system apparatus and the corresponding electrical wiring take up space in the field of view thereby obstructing a portion of the view, as well as a portion of the user's face, and might require continual adjustment to the users eye if the head or helmet-mounted assembly moves with respect to the eye.

There have also been attempts to create a virtual display system using eyeglasses. For example, U.S. Pat. No. 4,869,575 discloses a periscopic display that includes a reflecting prism portion and a collimating lens portion that are mounted on an arm, and the arm is attached to the frame of the eyewear. Similarly, U.S. Pat. No. 6,023,372 discloses a compact display device that is mounted on an arm, and the arm is attached to the eyewear frame.

From the foregoing, it remains desirable to have a compact, lightweight, hands-free virtual display system with minimal obscuration that is capable of being integrated with common eyewear, and which provides a wide field of view.

### SUMMARY

The present disclosure describes a compact, lightweight, virtual display system that is advantageously mounted for use on conventional style eyewear providing minimal obscuration and hands free operation. In a preferred arrangement, at least one opening is formed in a lens of the eyewear, and a grommet is adapted to snugly fit into the opening. A housing is adapted to snugly fit into the grommet. The housing preferably includes a ball and socket assembly, wherein the ball is rotatable within the socket. A collimating apparatus is adapted to fit within the ball. The collimating apparatus may therefore be adjusted by the user. Once adjusted, there is no need for further adjustment thereby making the device “hands-free.”

In alternative embodiments, the display system may be affixed to the eyewear by mechanical or magnetic clips or by an adhesive mixture.

A further understanding of the nature and advantages of the present invention may be realized by reference to the remaining portions of the specification and the drawings.

### BRIEF DESCRIPTION OF THE DRAWINGS

FIG. 1 is an exploded perspective view illustrating a preferred embodiment.

FIG. 2 is a perspective view illustrating the embodiment shown in FIG. 1.

FIG. 3 is a perspective view illustrating details of the housing assembly.

FIG. 4 is a perspective view illustrating an alternative embodiment.

FIGS. 5A and 5B are perspective views illustrating an alternative embodiment.

FIGS. 6A and 6B are perspective views illustrating an alternative embodiment.

FIG. 7 is a perspective view illustrating an alternative embodiment assembly.

FIG. 8 is an exploded perspective view illustrating an alternative embodiment.

FIG. 9 is a perspective view illustrating additional details of the housing assembly.

### DETAILED DESCRIPTION OF SPECIFIC EMBODIMENTS

The present disclosure describes a compact, lightweight virtual display system that is mounted on conventional eyewear. Advantageously, mounting the virtual display system in close proximity to the user's eye makes the display small and easy to view. In one embodiment, a housing for the display is snugly coupled through a grommet to an opening provided in the eyewear. In other embodiments, the eyewear does not have an opening for the display, and instead, the housing is coupled to the eyewear by mechanical clips or fasteners. In yet another embodiment, the housing is coupled to the eyewear by an adhesive. Finally, in one embodiment, the housing is coupled to the eyewear by magnetic force.

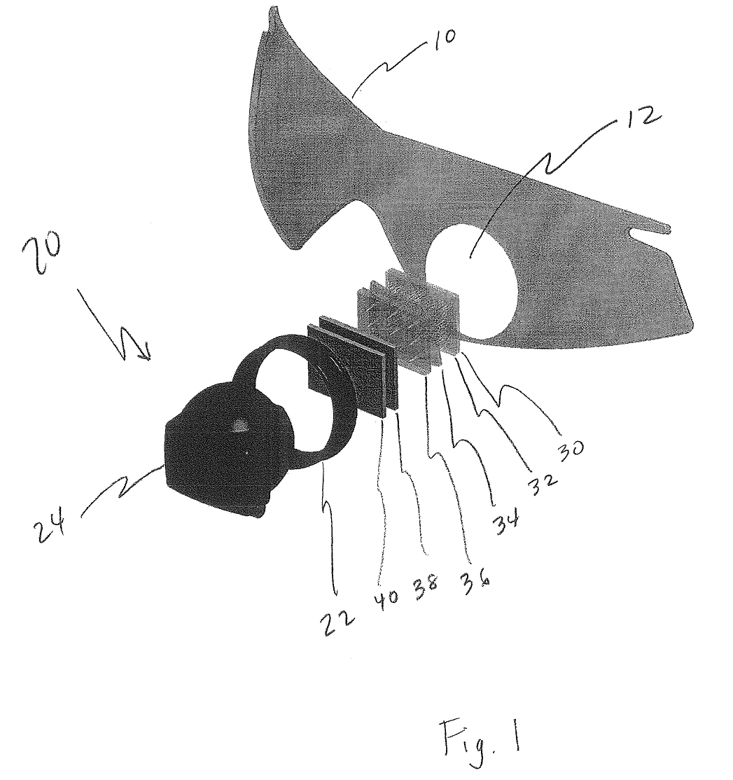

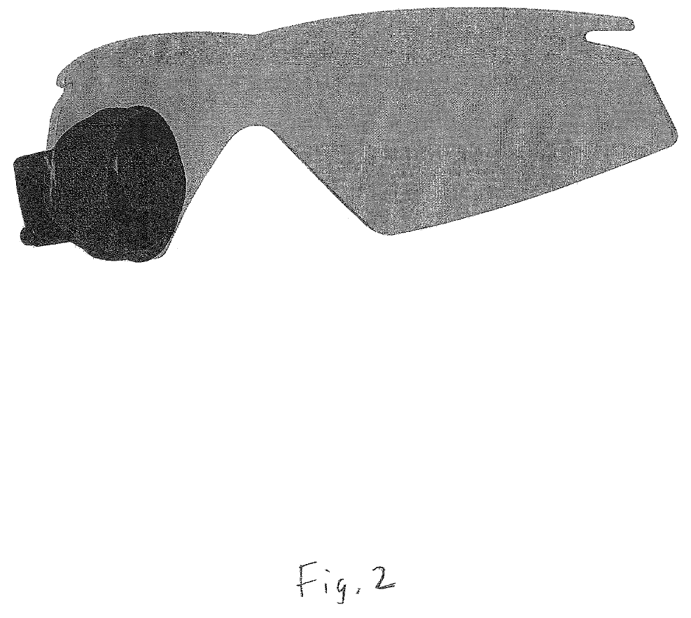

Referring now to FIGS. 1 and 2, a preferred embodiment of an eyewear-mounted virtual display system is illustrated. Eyewear 10 are preferably conventional style eyewear molded from lightweight plastic in a well-known manner. A circular opening 12 is formed in one of the lenses to accommodate a collimating display system apparatus 20. The opening is approximately 0.75 inches in diameter in this embodiment, but in general, will be appropriately sized to accommodate the collimating display system apparatus 20. The location of the opening is not critical and may be located according to user preference.

A grommet 22, preferably formed of plastic, is snap fit in place into opening 12. The collimating display system apparatus 20 includes a housing assembly 24, also formed of plastic, that is snap fit into place within the grommet 22. The housing assembly 24 includes a compact collimating system contained therein. For example, U.S. Pat. No. 6,075,651, the teachings of which are expressly incorporated herein by reference, discloses a preferred compact collimating system that is utilized in the present disclosure. Thus, the collimating system includes a polarization selective (“PS”) element 30, a first quarter-wave plate 32, a plano-concave lens 34, a second quarter-wave plate 36, a linear polarizing sheet 38, and an image source 40.

Advantageously, the PS element 30 reflects radiation having one polarization state while transmitting radiation having the orthogonal polarization state. For example, a preferred PS element is the ProFlux™ polarizer manufactured by Moxtek, Inc., which includes a thin layer of aluminum ribs formed onto a glass substrate. An alternative is provided by using a thin film material, such as the Dual Brightness Enhancement Film (“DBEF”) made by 3M®. Such material can be designed to efficiently reflect electromagnetic radiation in a broad band of wavelengths, for example visible light, that has a particular plane, or linear, polarization while transmitting light of an orthogonal polarization. For example, a PS element can be designed to reflect p-polarized visible light while transmitting s-polarized light. The PS element does not alter either the polarization of the transmitted light or the polarization of the reflected light.

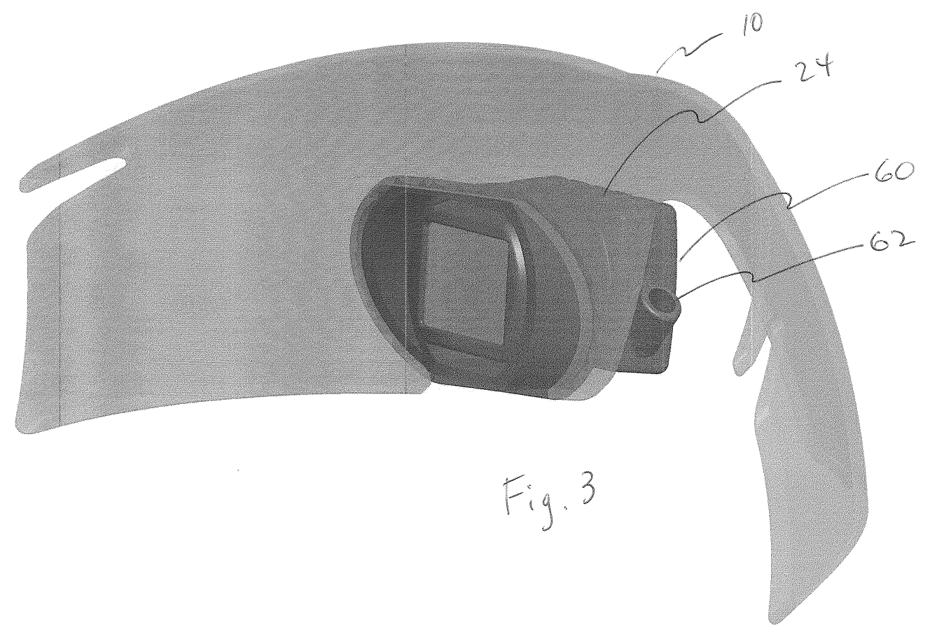

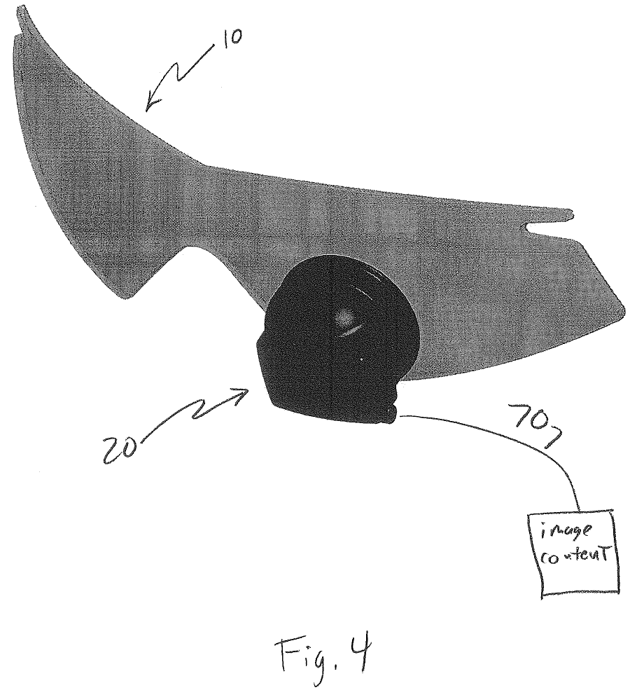

The image source 40 is preferably adapted for wireless operation. Therefore, a wireless receiver 60 including antenna 62 and battery (not shown) must be incorporated into the housing 24 in such a way as to minimize visual obstruction, for example, as shown in FIG. 3. The wireless receiver 60 is of well known construction. For example, in a preferred arrangement, not intended to be limiting, the wireless receiver may be adapted to operate in the frequency bands of 900 MHz and 2.4 GHz using an encoding scheme such as MPEG4 and a standard transport mechanism such as IEEE 802.11 for wireless communications. The battery is preferably a small lithium cell of the type used in cameras and the like. Alternatively, the image source may be hard-wired to source content via wire 70, as shown in FIG. 4.

It should be clear that the collimating display system apparatus 20 could be located anywhere on the eyewear. Further, although eyewear with only one collimating display system apparatus is shown (monocular), it should also be clear that the eyewear could incorporate two collimating display system apparatuses, one in each lens (binocular).

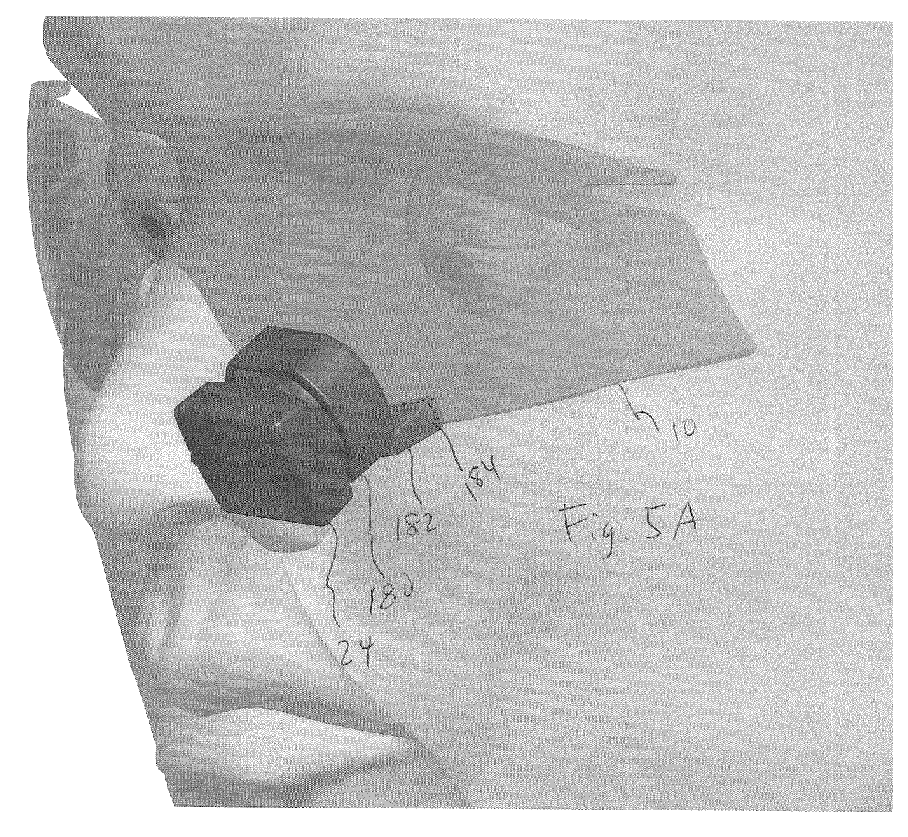

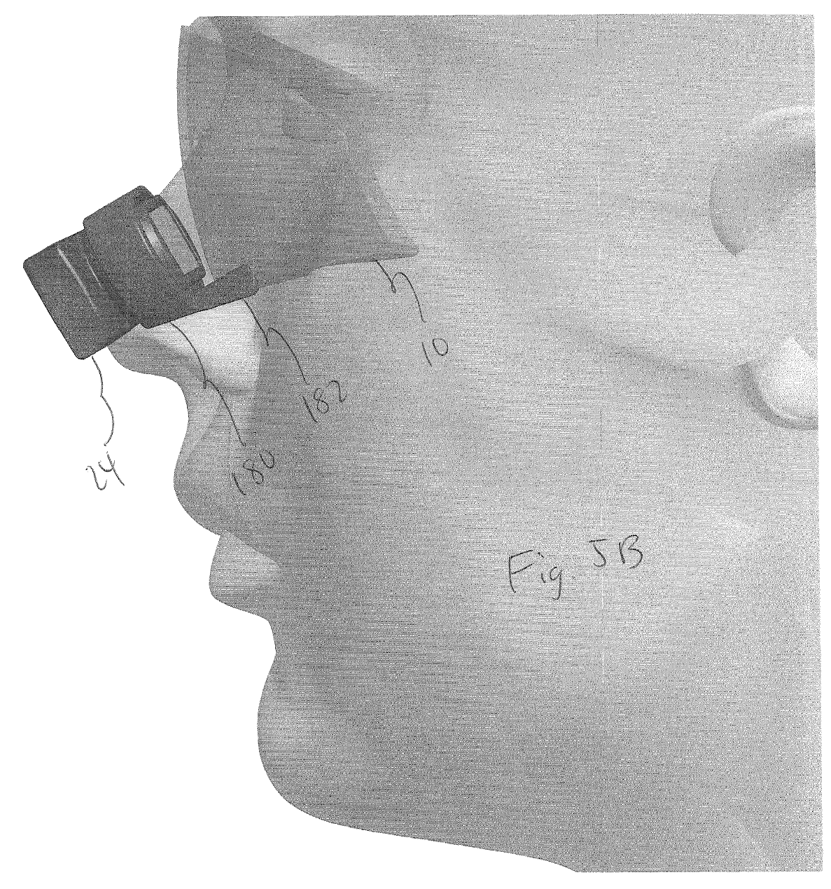

Other variations are contemplated for coupling the display device to the eyewear. For example, as illustrated in FIGS. 5A and 5B, instead of being snap fit into the grommet 22 (as in FIG. 1), the housing 24 is snap fit into a sleeve 180 that has a tab 182 extending from the sleeve. The tab includes a notch 184 which is sized to snap fit onto the eyewear 10, for example, on the exposed bottom portion of the eyewear or the frame.

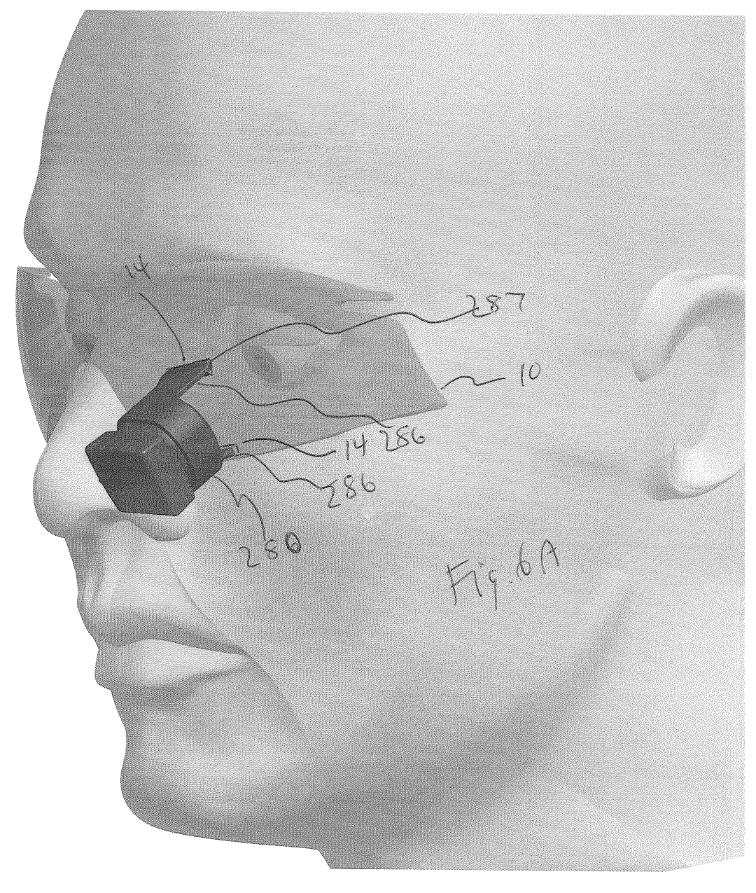

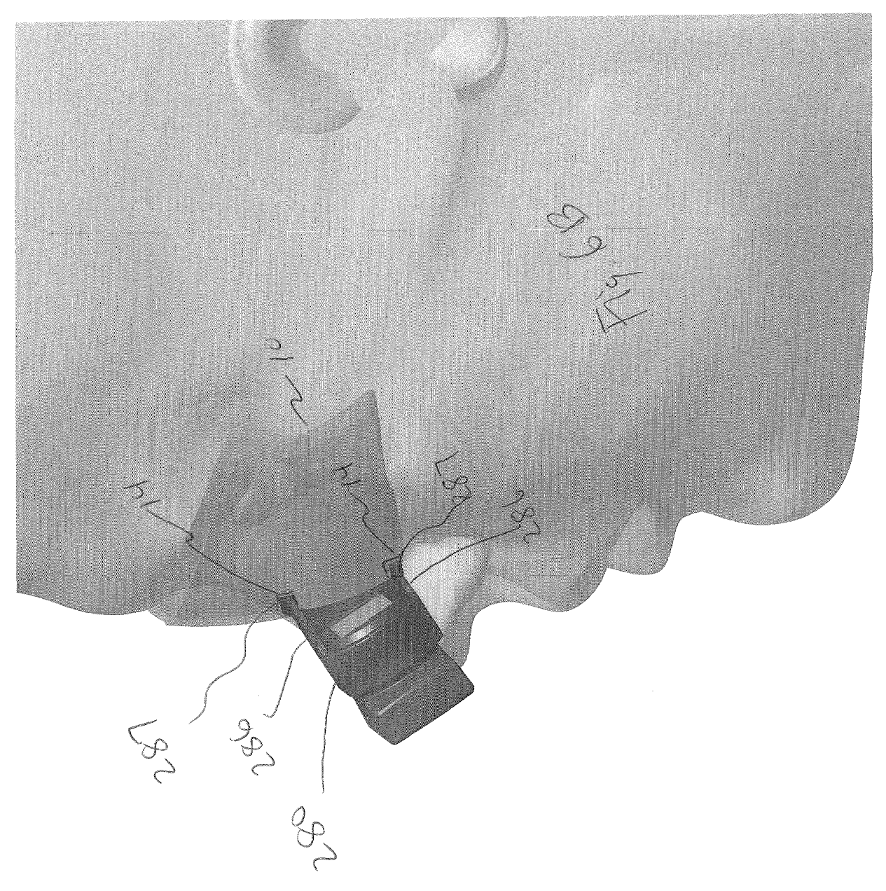

FIGS. 6A and 6B illustrate an alternative embodiment, wherein sleeve 280 includes a pair of tabs 286 extending from the top and bottom of the sleeve. Each of the tabs 286 has a locking portion 287 on the end thereof that permits the tabs to be inserted into corresponding slotted openings 14 in eyewear 10 and be held snugly by the locking portion.

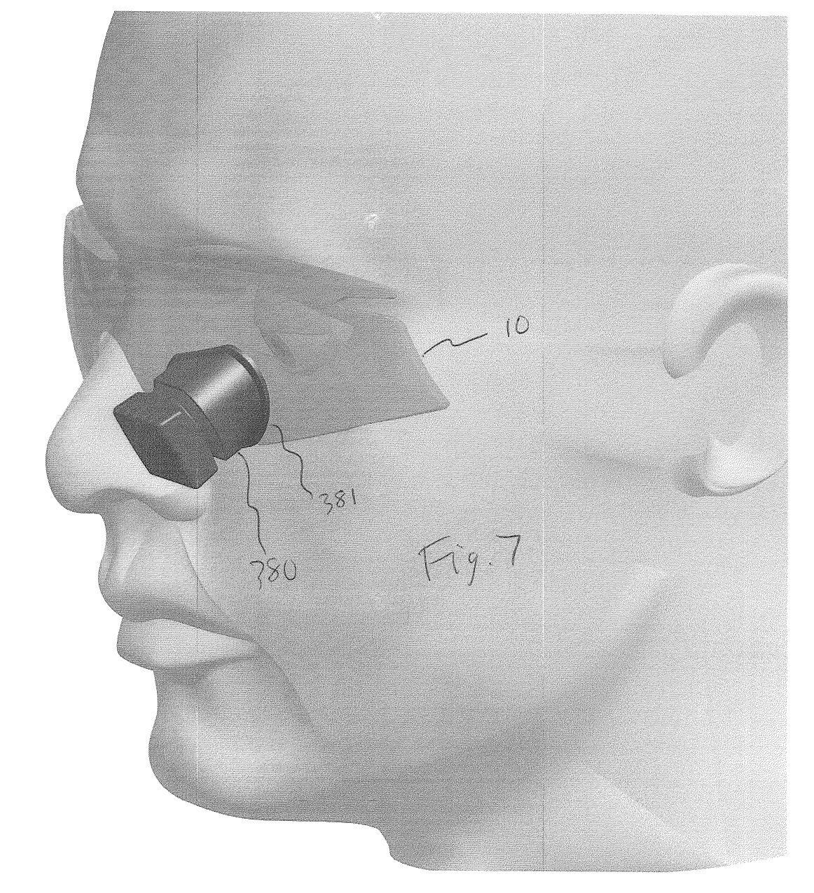

Yet another alternative embodiment is illustrated in FIG. 7, wherein housing 24 is snap fit into sleeve 380. The sleeve 380 includes a flange 381, which is attached to eyewear 10 by an adhesive mixture, such as an epoxy. Preferably, the flange 381 is somewhat malleable so that it may be adhered to eyewear having different curvatures.

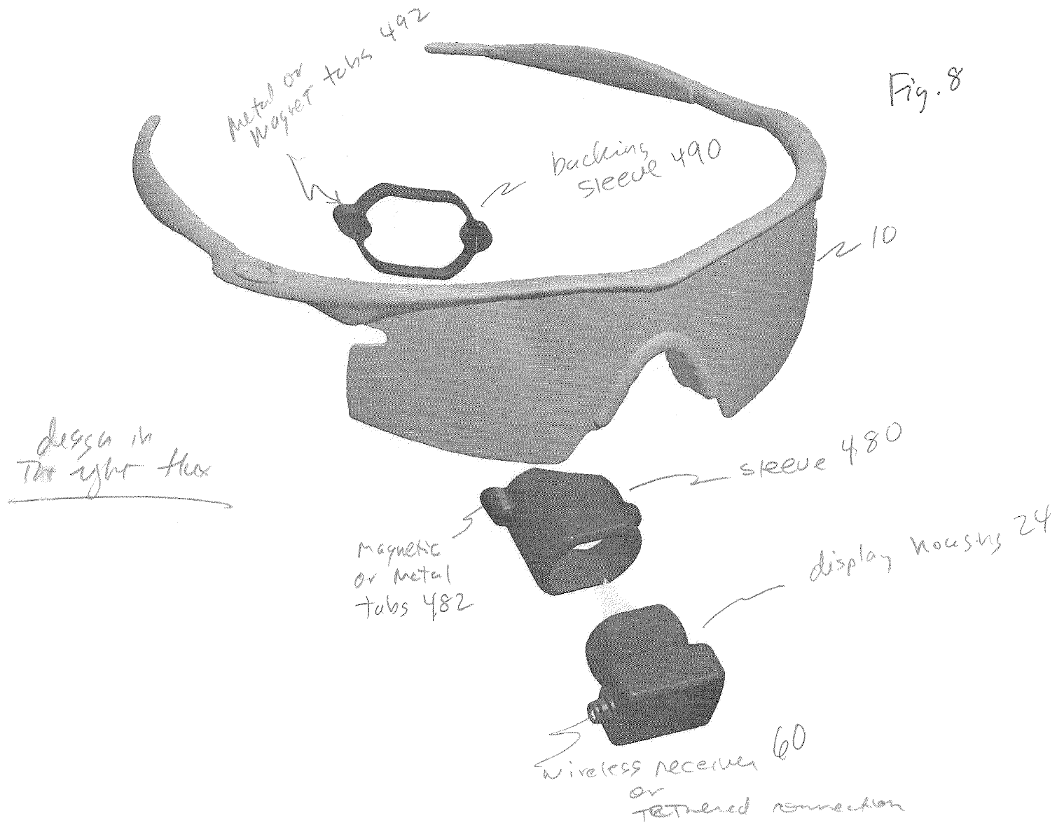

Another alternative embodiment is illustrated in FIG. 8, wherein the housing 24 is coupled to eyewear 10 by magnetism. For example, housing 24 is snap fit into sleeve 480, but in this embodiment, the sleeve includes tabs 482. The tabs 482 are molded from plastic together with the sleeve 480, but are formed to include either a magnetic material or a ferromagnetic material, such as iron or steel. A corresponding backing sleeve 490 having tabs 492 is positioned on the inside of the eyewear. Tabs 492 are molded from plastic together with the sleeve 490, but are formed to include either a magnetic material or a ferromagnetic material. Thus, tabs 482 on sleeve 480 are magnetically coupled to tabs 492 or sleeve 490 when these components are placed into a desired position on the surface of the eyewear. An adequate magnetic flux for providing a secure coupling must be designed into the materials used for tabs 482 or 492 in accord with well known design principles. For example, tabs 482 may include a small steel portion formed near the surface of the plastic tab, and tabs 492 may include a small magnetic portion and having a suitable magnetic flux near the surface of the plastic tab to attract and couple to tabs 482.

Each of the foregoing alternative embodiments thus permits the use of conventional glasses or protective eyewear without cutting or otherwise forming a hole in the lenses.

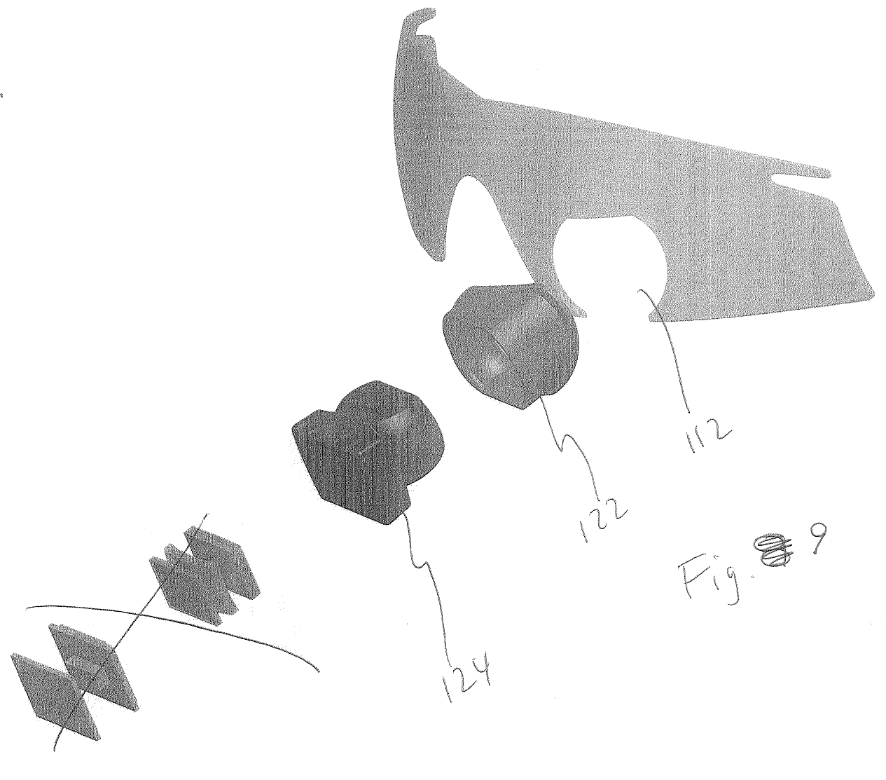

Referring now to FIG. 9, the housing 124 of the collimating system preferably includes a ball and socket configuration to allow for some degree of rotation of the display. The ball portion 125 is preferably rounded on each side, and flat on top and bottom. The ball portion 125 is snap fit into the socket portion, e.g., sleeve 122, such that the display can be easily rotated to adjust the angle relative to the user's eye.

The present disclosure thus provides a virtual display system that is mounted on eyewear. The display system is a lightweight collimating display system that provides the user with a large field of view in a small lightweight package. Advantageously, mounting the virtual display close to the eye makes the display small and easy to view. Even more importantly, such a mounting provides a minimal obstruction to the user's view thereby allowing the user to take advantage of unobstructed, hands-free binocular viewing.

In general, those skilled in the art to which this invention pertains will recognize that variations in construction and widely differing embodiments will suggest themselves without departing from the spirit and essential characteristics of the invention. Accordingly, the disclosures and descriptions herein are intended to be illustrative only, and not limiting. The scope of the invention is set forth in the claims.

I claim:

1. A virtual display system, comprising:
a pair of eyewear; and
a collimating display system apparatus coupled to the eyewear.

2. A virtual display system as in claim 1, wherein an opening is formed in a lens of the eyewear, and the collimating display system apparatus is coupled to the opening.

3. A virtual display system as in claim 1, wherein a notch is formed in the eyewear, and the collimating display system apparatus is coupled to the notch.

4. A virtual display system as in claim 1, wherein the collimating display system apparatus is coupled to the eyewear by a clip.

5. A virtual display system as in claim 1, wherein the collimating display system apparatus is adhesively coupled to the eyewear.

6. A virtual display system as in claim 1, wherein the collimating display system apparatus is magnetically coupled to the eyewear.

7. A virtual display system as in claim 2, wherein the collimating display system apparatus is positioned within a housing, and the housing is coupled to the opening.

8. A virtual display system as in claim 7, wherein the housing includes a ball rotatably mounted within a socket, and wherein the collimating display system apparatus is positioned inside the ball.

9. A virtual display system as in claim 1, wherein the collimating display system apparatus includes an image source, and wherein the image source receives an image signal via a wired connection.

10. A virtual display system as in claim 1, wherein the collimating display system apparatus includes an image source, and wherein the image source receives an image signal via a wireless connection.

11. A virtual display system, comprising:
eyewear having a pair of lenses therein;
at least one opening formed in at least one of the lenses;
a grommet adapted to fit into the opening;
a housing adapted to fit into the grommet, including a ball and socket assembly, wherein the ball is rotatable within the socket; and
a collimating display system apparatus adapted to fit within the ball.

12. A virtual display system, comprising:
a pair of eyewear;
a first sleeve having magnetic tabs and positioned on a front surface of the eyewear;
a second sleeve having magnetic tabs and positioned on a rear surface of the eyewear in correspondence with the first sleeve; and
a collimating display system apparatus adapted to fit within the first sleeve.

13. A virtual display system as in claim 12, wherein the collimating display system apparatus includes a ball and socket assembly, wherein the ball is rotatable within the sleeve.
